(19) United States
(12) Patent Application Publication
(10) Pub. No.: US 2022/0300888 A1
(43) Pub. Date: Sep. 22, 2022

(54) AUTOMATED DISPATCH OF FIELD PERSONNEL FOR ON-SITE SERVICES

(71) Applicant: Anthony Benson, Puyallup, WA (US)

(72) Inventor: Anthony Benson, Puyallup, WA (US)

(21) Appl. No.: 17/696,558

(22) Filed: Mar. 16, 2022

Related U.S. Application Data
(60) Provisional application No. 63/162,498, filed on Mar. 17, 2021.

(51) Int. Cl. G06Q 10/06

(52) U.S. Cl. CPC G06Q 10/063116

(57) ABSTRACT

Techniques for automating dispatching of one or more field personnel to support a batch of service requests for appointments from multiple requestor devices are described. In one example, an on-site service management application may implement a scheduling algorithm that uses optimization variables to calculate an optimum cost of dispatching one or more field personnel to fulfill the batch of service requests. Because there is multiple field personnel who can serve the requests, the on-site service management application may schedule the availability and/or reorganize the field personnel schedule substantively in real-time. This technique may improve customer or requestor experience and minimizes costs on the part of the service providers.

### CROSS-REFERENCE TO RELATED APPLICATION

This application claims the benefit of U.S. Provisional Application No. 63/162,498 filed Mar. 17, 2021, and titled “AUTOMATED DISPATCH OF FIELD PERSONNEL FOR ON-SITE SERVICES,” which is herein incorporated by reference in its entirety.

### BACKGROUND

Companies providing on-site services such as notarial services, plumbing services, HVAC repairs, general construction services that provide a combination of electrical/plumbing services, etc. may typically dispatch one or more service providers (field personnel) to customers' locations. Typically, the field personnel receive dispatched requests for services and manually call the on-site service customers (requestors) to schedule appointments according to the customers' schedules and information associated with the service request. The associated information may include a type of service requested, requested time of service, venue for rendering the service, length of availability of the requestor, and the like. However, this process is inefficient because it requires a manual process to reorganize schedules as new service requests are dispatched. Furthermore, a batch of requestors are generally scattered in different locations and their requested time of service may require calculations and comparisons between expected time of arrivals (ETAs) of the field personnel to improve efficiency in field personnel deployment.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 is an example diagram of an example cellular network environment in which dispatching of field personnel for on-site services may be implemented, in accordance with at least one embodiment.

FIG. 2 is an example diagram of a network server environment that implements an automated dispatch of the field personnel for the on-site services, in accordance with at least one embodiment.

FIG. 3 is an example block diagram of a network server that can be used as a dispatch center server to manage the dispatching of the field personnel for the on-site services, in accordance with at least one embodiment.

FIG. 4 is an example diagram of a scheduling algorithm that may be used by an on-site services management platform to calculate an optimum operating cost, in accordance with at least one embodiment.

FIG. 5 is an example calendar schedule of a user device that may be updated following a selection of an available field personnel to be dispatched to fulfill service requests, in accordance with at least one embodiment

FIG. 6 is a flow diagram of an example methodological implementation for updating calendar schedules of user devices associated with identified one or more field personnel to be dispatched to fulfill service requests, in accordance with at least one embodiment.

FIG. 7 is a flow diagram of an example methodological implementation for performing a scheduling algorithm to identify the field personnel to be dispatched, in accordance with at least one embodiment.

FIG. 8 is a flow diagram of an example methodological implementation for updating a user device—calendar schedule of identified field personnel to be dispatched, in accordance with at least one embodiment.

### DETAILED DESCRIPTION

### Overview

This disclosure is directed to techniques for automating dispatching of one or more field personnel to support a batch of service requests for appointments from multiple requestor devices. Requestor devices may include a mobile device, laptop, personal digital assistant (PDA), multimedia device, or any other similar functioning device. The service requests may be for a particular type of service such as, without limitation, notarial services, plumbing services, or electrical services. In one example, an on-site service management application (or on-site service app) may be configured to run a scheduling algorithm such as a linear programming algorithm that utilizes optimization variables for calculating an optimum operating cost (or maximum profits) of dispatching one or more field personnel to fulfill the batch of service requests. The optimization variables may include mathematical symbols to represent physical quantities. The optimum operating cost may satisfy constraint functions and/or other conditions of making the dispatch. Without limitation, the optimization variables may represent a requested time and site for the service, current calendar schedule or itineraries of prospective field personnel to be dispatched, time preference of the field personnel, field personnel preference of a customer (or requestor), travel distance, cost per mile, service fees, and/or the like. Following a calculation of the optimum operating cost for dispatching the one or more field personnel to fulfill the batch of service requests, the on-site service app may access and automatically update the calendar schedule of one or more user devices associated with the one or more field personnel to be dispatched. The on-site service app may then send a notification of the dispatch to each of the one or more requestor devices. In a case where the requestor device rejects a scheduled dispatch, the on-site service app may run again the scheduling algorithm to update the calendar schedules of the user devices associated with the dispatched one or more field personnel. Because there are multiple field personnel who can serve the service requests, the on-site service app may schedule the availability and/or reorganize field personnel schedule substantially in real-time. This technique may improve customer or requestor experience and minimizes costs on the part of the service providers.

In a linear programming algorithm embodiment of a scheduling algorithm, a linear function may be maximized. In the present case, for example, revenue and/or a number of engagements to be performed by the field personnel may be maximized. A set of variables are determined to define a linear programming basis (i.e., the variables that comprise the vectors span the linear space of the linear programming model) and represent constraints in the form of that basis. For example, in the case where revenue is to be maximized, costs may be modeled as a linear function of revenues from different types of engagements and different types of engagements treated as the basis for the linear programming model. The result may include a calculation of how many types of different engagements can be scheduled.

In an embodiment, the calculation of the optimum operating cost for dispatching the one or more field personnel to fulfill the batch of service requests may provide or at least indicate the availability of the one or more field personnel. For example, the scheduling algorithm may facilitate an identification of particular field personnel who can serve a set of service requestor appointments over a particular sequence with optimum operating cost. In this example, the scheduling algorithm may identify corresponding user device(s) that can be associated with the particular field personnel. The on-site service app may then perform the updating of the calendar schedule of the particular field personnel upon confirmation by the requestor device.

In one example, following the calculation of the minimal operating cost for dispatching the one or more personnel to fulfill the batch of service requests, the on-site service app may send computer-executable instructions that can present one or more identified field personnel selections to user interfaces of the requestor devices before finalizing the one or more identified field personnel to be dispatched. The one or more field personnel selections may include available field personnel who can be dispatched to perform the service. Based upon one or more selections received from the requestor devices, the on-site service app may update the calendar schedule of the field personnel to be dispatched. However, in case of cancellation or rejection by the requestor devices, the on-site service app may perform another recalculation to determine the minimal cost of dispatching the one or more field personnel. In one embodiment, the on-site service app may first ask for confirmation from the requestor devices before updating the calendar schedule of the one or more field personnel to be dispatched. Further, the on-site service app may periodically run the scheduling algorithm upon detection of changes in the optimization variable such as a last-minute notice of cancellation by the requestor device.

Details regarding the novel techniques reference above are presented herein are described in detail, below, with respect to several figures that identify elements and operations used in systems, devices, methods, and computer-readable storage media that implement the techniques.

### Example Network Environment

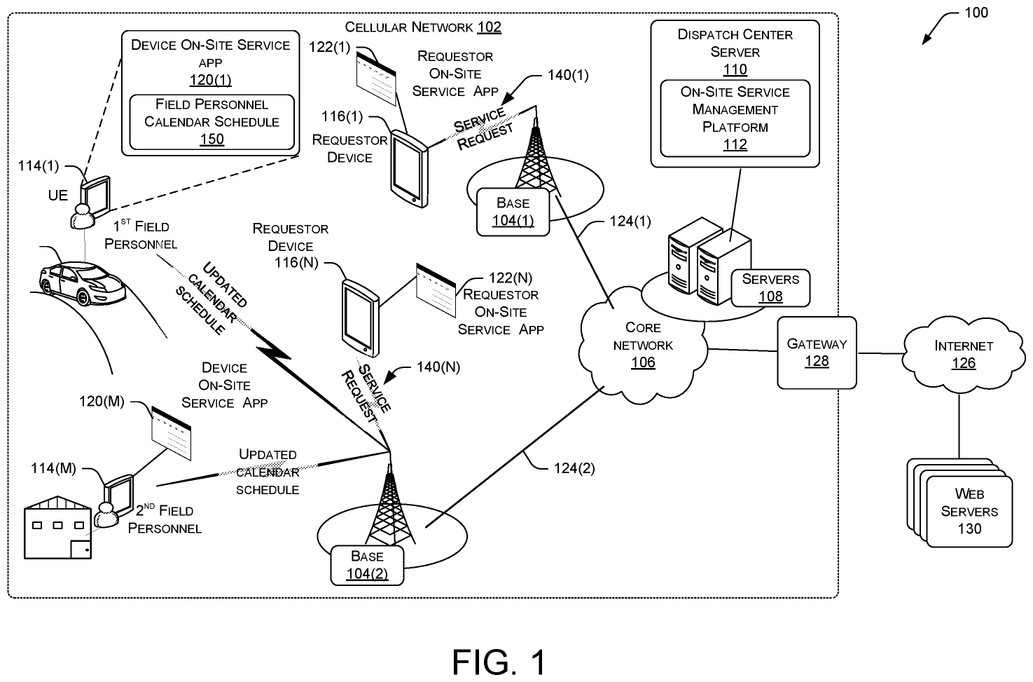

FIG. 1 is a diagram of an example cellular network environment 100 in which the technological solutions described herein may be implemented. FIG. 1 illustrates a concept of managing calendar schedules of a plurality of field personnel who may be dispatched to fulfill multiple service requests from different locations. In one embodiment, a dispatch center server may run a scheduling algorithm using one or more optimization variables to calculate an optimum operating cost of dispatching the one or more field personnel to fulfill service requests from requestor devices. The optimum operating cost may generate maximum profits to a service provider such as a notarial service provider while providing an improved customer experience to service requestors.

As shown, the cellular network environment 100 may include a cellular network 102 that is provided by a wireless telecommunication carrier. It is noted that, although the present discussion refers to a cellular network, other network architectures may be used in place of the cellular network shown and described with respect to FIG. 1. The cellular network 102 includes, for example, cellular network base stations 104(1)-104(2) and a core network 106. The core network 106 may further include one or more servers 108 such as a dispatch center server 110, which implements an on-site service management platform 112 (hereinafter referred to as on-site service platform 112). The on-site service platform 112 may manage the scheduling of field personnel associated with user devices 114(1)-114(M) to fulfill a batch of service requests, such as the service requests coming from requestor devices 116(1)-116(N). Each of the user devices 114(1)-114(M) may include device on-site service app 120(1)-120(M), respectively. Further, each of the requestor devices 116(1)-116(N) may include requestor on-site service app 122(1)-122(N), respectively, where “M” and “N” are arbitrary integers.

Each one of the base stations 104(1)-104(2) may serve as a hub of the local wireless network and/or a gateway between a wired network and a wireless network. The base stations 104(1)-104(2) are responsible for handling data traffic between each of the user devices 114(1)-114(M) and the dispatch center server 110. Further, the base stations 104(1)-104(2) are responsible for establishing wireless communications between requestor devices 116(1)-116(N) and the on-site service platform 112. Each of the base stations 104(1)-104(2) may be communicatively connected to the core network 106 via a corresponding backhaul 124(1)-124(2). Each of the backhauls 124(1)-124(2) may be implemented using copper cables, fiber optic cables, microwave radio transceivers, and/or the like. Accordingly, each one of the user devices 114(1)-114(M) and the requestor devices 116(1)-116(N) may connect to the on-site service platform 112 via the base station 104 and the core network 106. The core network 106 may provide telecommunication and data communication in accordance with one or more technical standards, such as Enhanced Data Rates for GSM Evolution (EDGE), Wideband Code Division Multiple Access (W-CDMA), HSPA, LTE, LTE-Advanced, CDMA-2000 (Code Division Multiple Access 2000), 5G and/or so forth.

Each of the user devices 114 or requestor devices 116 may include an electronic communication device such as a cellular phone, a smartphone, a session initiation protocol (SIP) phone, a laptop, a PDA, a satellite radio, a global positioning system (GPS), IoT devices with tracking mechanism, a multimedia device, a video device, a camera, a game console, a tablet, a smart device, a wearable device, or any other similar functioning device. Further, each of the user devices 114 and requestor devices 116 may be capable of connecting to an Internet 126 via a gateway 128. Additionally, apart from the cellular network 102, the cellular network environment 100 includes multiple web servers 130 that may be accessed through the Internet 126.

In an example embodiment, the on-site service platform 112 may be configured to manage fulfillment of the one or more service requests from the requestor devices 116(1)-116(N). The fulfillment of the one or more service requests may include the hiring of field personnel who are associated with one or more user devices 114. In one example, the on-site service platform 112 may store device identifications of subscriber devices, device geolocations, associated field personnel names, device calendar schedules that include associated field personnel itineraries and current availabilities, and/or other information that relates to the dispatching of the field personnel to render services. The information may include the type of service(s) catered by the field personnel such as notarial services, preferred time of availability, preferred geographic area for rendering service, requested time and site of service, and/or the like. In this example, the on-site service platform 112 may use the stored information as decision or optimization variables in one or more constraint functions of a scheduling algorithm to define an objective function, which includes a calculation of optimum operating cost for dispatching the one or more field personnel to cover the service requests. In some cases, a nearest neighbor algorithm may be used to calculate the optimum operating cost. The one or more constraints may include functional equalities or inequalities that represent restrictions on what numerical values can be assigned to the decision variables. The decision variables may include values that may be controlled or chosen to set components to be optimized to their optimum value. The decision variable that may be used to obtain the optimum operating cost may also be referred to as optimization variables.

In one example, the dispatch center server 110 may receive one or more service requests 140(1)-140(N) from the requestor devices 116(1)-116(N), respectively, for service appointments. Each of the service requests 140(1)-140(N) may include parameters such as requested time and site of service, requestor preference for field personnel to be dispatched, device identification, length of service, and/or similar information that relates to the fulfillment of the service request. In this example, the on-site service platform 112 may parse each of the received service requests 140 to obtain the information that can be used as optimization variables for the constraint functions.

In one embodiment, the parameters may be parsed and entered into preconfigured optimization variables that are utilized by a scheduling algorithm to generate the optimum operating cost. For example, a preconfigured optimization variable may represent a physical distance between the current location of the available field personnel and the site of service. The available field personnel may be determined by comparing the requested time of service with associated user device—calendar schedule. In this example, a constraint function may limit a value of the physical distance to within a particular radius for example. With the values entered into corresponding preconfigured optimization variables, the on-site service platform 112 may be configured to run the scheduling algorithm, which can use linear programming, to calculate the optimum operating cost for dispatching the one or more field personnel to cover the one or more service requests 140.

Following a determination of the optimum operating cost and an identification of an available field personnel to be dispatched, calendar schedules of the user devices associated with the identified field personnel can be updated. In some cases, the updating of the identified field personnel may be performed after confirmation by the requestor device or devices. For example, the on-site service platform 112 may transmit computer-executable instructions that can present identified field personnel on a user interface of the requestor device. In this example, the requestor device may confirm or decline the presented identified field personnel.

In one example, the network server such as the dispatch center server 110 may use a database (not shown) to track itineraries of the field personnel that can likely fulfill the service requests. In this example, the dispatch center server 110 may track the itinerary of the field personnel via the user device—on-site service app 120 that can be configured to communicate with a calendar app in the user device. With the obtained itineraries, the on-site service platform 112 may filter the field personnel that are not available to fulfill the service request at the requested time of service. The filtering may be performed after running the scheduling algorithm by presenting only the available field personnel for selections or confirmations by the requesting devices. Upon confirmation, the on-site service platform 112 may automatically update the calendar schedule of the confirmed field personnel. In one instance, the calendar schedule of the identified field personnel may be represented by a personnel calendar schedule 150 of the user device 114(1). The personnel calendar schedule 150 may include dispatches assigned to the user device 114(1). Following the updating of the field personnel calendar schedule, the on-site service platform 112 may dispatch the identified field personnel to fulfill/serve the corresponding service request 140.

In some instances, the on-site service platform 112 may be configured to transmit computer-executable instructions that can present one or more identified field personnel selections to user interfaces of the requestor devices before finalizing the dispatch. The one or more identified field personnel may include the available field personnel upon comparison of the requested time of service and the calendar schedule of the field personnel. Instead of automatically updating the calendar schedule of the identified and available field personnel, the on-site service platform 112 may first wait for the recipient requestor devices to respond to the transmitted field personnel selections. For example, following the determination of the optimum operating cost by the on-site service platform 112, a field personnel selection may be communicated to the requestor devices 116(1)-116(N). The field personnel selection may include the field personnel who were identified to be available for rendering the requested service. In this example, the customer/requestor may confirm or decline the field personnel selection option within a particular period such as within one hour of receiving the notification of the assigned field personnel. In a case where the customer confirms the field personnel, then the on-site service platform 112 may automatically update the stored calendar schedule of the corresponding field personnel as described herein.

In various embodiments such as when the on-site service platform 112 detects one or more changes on the decision variables and/or optimization variables, the on-site service platform 112 may run again the scheduling algorithm to manage in real-time the scheduling and calendar of the field personnel.

### Example Network Server Environment

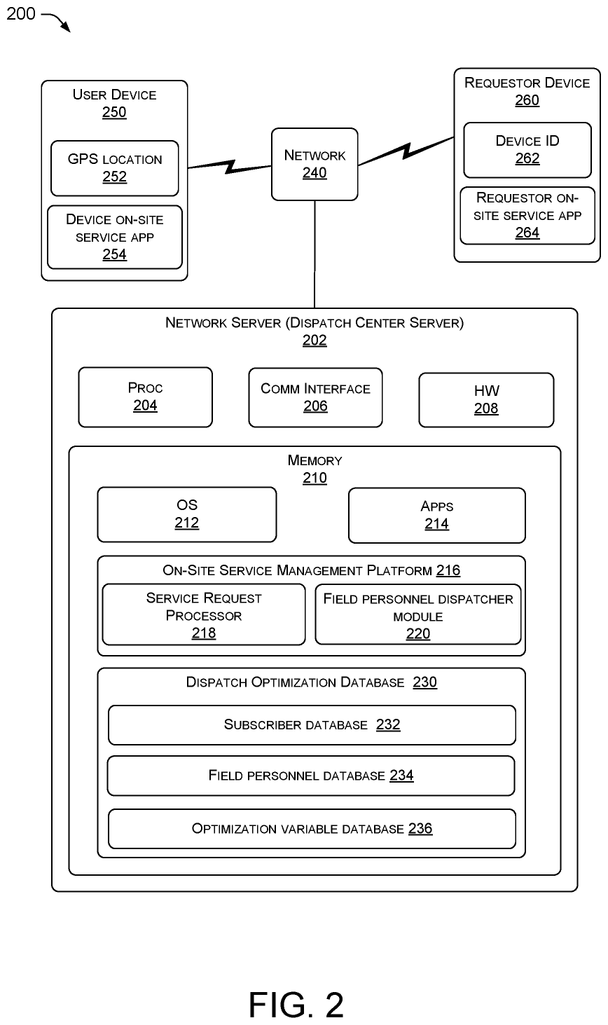

FIG. 2 is a diagram of an example network server environment 200 in accordance with the technologies described herein. The network server environment 200 includes a network server 202 that corresponds to the dispatch center server 110 of FIG. 1. The network server 202 may be communicatively connected, via a network 240, to a user device 250 and a requestor device 260. The user device 250 and the requestor device 260 correspond to the user device 114 and the requestor device 116, respectively, of FIG. 1.

The network server 202 includes one or more processors 204 having electronic circuitry that executes instruction code segments by performing basic arithmetic, logical, control, memory, and input/output (I/O) operations specified by the instruction code. The processors 204 can be a product that is commercially available through companies such as Intel® or AMID®, or it can be one that is customized to work with and control a particular system.

The network server 202 also includes a communications interface 206 and miscellaneous hardware 208. The communication interface 206 may communicate with components located outside the network server 202 and provide networking capabilities for the network server 202. For example, the network server 202, by way of the communications interface 206, may track locations of the user devices and/or collect service requests from the requestor devices. Communications between the network server 202 and the user devices or requestor devices may utilize any sort of communication protocol known in the art for sending and receiving data and/or voice communications.

The miscellaneous hardware 208 includes hardware components and associated software and/or firmware used to carry out device operations. Included in the miscellaneous hardware 208 are one or more user interface hardware components not shown individually—such as a keyboard, a mouse, a display, a microphone, a camera, and/or the like—that support user interaction with the network server 202.

The network server 202 also includes memory 210 that stores data, executable instructions, modules, components, data structures, etc. The memory 210 may be implemented using computer-readable media. Computer-readable media includes, at least, two types of computer-readable media, namely computer-readable storage media and communications media. Computer-readable storage media includes, but is not limited to, Random Access Memory (RAM), Dynamic Random Access Memory (DRAM), Read-Only Memory (ROM), Electrically Erasable Programmable Read-Only Memory (EEPROM), flash memory or other memory technology, Compact Disc—Read-Only Memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by, modulated data signals, such as a carrier wave. In contrast, communication media may embody computer-readable instructions, data structures, program modules, or other data in a modulated data signal, such as a carrier wave, or other transmission mechanisms.

An operating system 212 may be stored in the memory 210 of the network server 202. The operating system 212 can control a functionality of the processor(s) 204, the communications interface 206, the miscellaneous hardware 208, and couples the processor(s) 204 with the memory 210. Furthermore, the operating system 212 may include components that enable the network server 202 to receive and transmit data via various inputs (e.g., user controls, network interfaces, and/or memory devices), as well as process data using the processor(s) 204 to generate output. The operating system 212 can include a presentation component that controls presentation of output (e.g., display the data on an electronic display, store the data in memory, transmit the data to another electronic device, etc.). Additionally, the operating system 212 can include other components that perform various additional functions generally associated with a typical operating system. The memory 210 that is in communication with the processor(s) 204 also stores various software applications 214, or programs, that provide or support functionality for the network server 202, or provide a general or specialized device user function that may or may not be related to the example computing device per se.

The one or more processors 204 and the memory 210 may implement an on-site service management platform 216 that corresponds to the on-site service platform 112 of FIG. 1. Such software may include routines, program instructions, objects, and/or data structures that are executed by the processors 204 to perform particular tasks or implement particular abstract data types. The one or more processors 204 in conjunction with the on-site service management platform 216 may further operate and utilize a service request processor 218, a field personnel dispatcher module 220, and a dispatch optimization database 230 including a subscriber database 232, a field personnel database 234, and an optimization variable database 236.

The on-site service management platform 216, when executed, may manage the calendar schedules of the user devices associated with the field personnel to be dispatched. The on-site service management platform 216 may run, for example, a scheduling algorithm to calculate the optimum operating cost or maximum profits scenario of dispatching the field personnel to service the requests. The on-site management platform 216 may be a single block of executable instructions or it may be made up of several components. The components included in at least one implementation are described below. However, it is noted that in other implementations, more or fewer components may be configured and that one or more operations attributed to a particular component in the following description may be implemented in one or more other components.

The service request processor 218 may process the one or more service requests that can be received from the requestor devices, such as the service requests 140 from respective requestor devices 116 of FIG. 1. One functionality of the service request processor 218 is to verify the source of the service request. For example, the service request processor 218 may parse the parameters of the received service request and use the parsed parameters such as the device identification of the requestor device 260 to verify whether the device identification is associated with subscription information that the requestor provided during an initial sign up. When the requestor signs up for the on-site service management application, the requestor may enter a name, username, address, service provider or field personnel preferences, device identification, and/or other information that relate to the requesting of service appointments via the on-site service management platform 216. Conversely, when the service provider or the field personnel signs up for the on-site service management application, the service provider or field personnel may enter a name, username, address, availability preferences, geographical location preferences, device identification, and/or other information that relate to the fulfillment of the service requests. In this example, the service request processor 218 may utilize the parsed parameters and other information in the subscriber database 232 to verify the service request.

Another functionality of the service request processor 218 may be to queue the received service requests, for example, according to the time that they were received. In this example, the service request processor 218 may be configured to collate batches of service requests based on the time of receipts. In one example, the collated batches of service requests to be processed for dispatch may include the service requests that were received within a preconfigured time duration such as the service requests that were received in the last one hour. In other cases, the batches of service requests may be gathered from a particular geographical location. In this case, the service request processor 218 may be configured to collate the batches of service requests based on geographical areas of the associated sites of services.

The field personnel dispatcher module 220 may be configured to implement the scheduling algorithm that optimizes the operating cost of dispatching one or more field personnel to fulfill the one or more service requests. In one example, the scheduling algorithm may use the linear programming that utilizes the parsed parameters or information from the received service requests. The parsed information may include the device identification, requested time and site of service, name of the requestor, type of service, length of service, service fees, preferred availability of the field personnel, and/or the like. In addition to stored parameters in the database that are associated with the requestor device, the field personnel dispatcher module 220 may enter or utilize the parsed parameters in the preconfigured optimization variables that can be used by the scheduling algorithm in finding the optimum operating cost.

In one embodiment, constraint functions may utilize the preconfigured optimization variables where the constraint functions may represent restrictions on what numerical values can be assigned to the optimization variables. For example, a cost of dispatch from the current geolocation of the field personnel to a particular site of service may use the parsed values of time and site of service. The time and site of service may dictate the timing of driving to the site of service by the dispatched field personnel. In another example, the constraint function may include a total number of dispatches to be less than or equal to the number of service requests, and so on. In these examples, the preconfigured optimization variables may be supplied with values of the parsed information, and the constraint functions may be adapted and used in the scheduling algorithm to calculate the optimum operating cost.

Following the calculation of the optimum operating cost, the field personnel dispatcher module 220 may identify the field personnel to be dispatched. For example, the scheduling algorithm generates an output that can include dispatching of field personnel to fulfill a set of ten service requests in a sequential manner to obtain optimum operating cost. In this example, the sequence provided by the scheduling algorithm is substantially fixed unless there is a detection by the field personnel dispatcher module 220 of one or more changes in the parameters. In case of detecting one or more changes, the field personnel dispatcher module 220 may again run the scheduling algorithm to update the one or more field personnel to be presented for confirmation to the requestor devices. In one embodiment, the one or more presented field personnel may include the field personnel that are determined to be available at the requested time of service. The availability of the field personnel may be performed by accessing the calendar schedule of the user device associated with the field personnel.

The subscriber database 232 may store the information and/or parameters associated with subscriptions to the on-site service management application. In one example, the information may include personal information of the subscriber, the device identification of subscriber's requestor device, cost preference of the subscriber, field personnel preference of the subscriber, and/or other information that relates to requesting of a particular type of service via the on-site service management application. In another example, the information may include a usage history associated with each of the subscribers. The usage history may include the previous service requests made by the subscriber, the corresponding field personnel that served the request, the completed reports for each of the past transactions such as completed reports of notarial transactions, the cancellations of dispatches received by the subscriber, and/or the like.

The field personnel database 234 may store the information associated with field personnel who subscribed to the on-site service management application. In one example, the information may include personal information of the field personnel, the device identification of field personnel's user device, calendar schedules of each of the field personnel's user devices, cost preference of the field personnel, field personnel preference of availability, field personnel preference of length of service, and/or the like. In another example, the information may include previous dispatches made by the field personnel, completed reports of dispatches that can be sent to agencies for tax purposes or any kind of reporting, and/or the like.

The optimization variable database 236 may store the preconfigured optimization variables associated with the implementation of the scheduling algorithm. Different optimization variables may be utilized for different types of services. In one example, the preconfigured optimization variables may be associated with constraint functions that are to be satisfied by the calculated optimum operating cost. Because there are different variables to be maximized or minimized, different corresponding optimization variables may be stored in the optimization variable database 236. For example, the optimization variables that correspond to the finding of the fastest route may be different from the optimization variables that correspond to maximizing profits. In this example, processors 204 in conjunction with the field personnel dispatcher module 220 may access the corresponding preconfigured optimization variables for the scheduling algorithm according to the objective function to be calculated.

In some implementations, the dispatch optimization database 230 may store reports of completed transactions. The reports may include the time and site of services rendered, information about the customers or requestors, cost, and/or other information. In one example, a completed transaction report such as notarization of a particular document may be sent to the requestor or customer by email, text messaging, and/or other forms of paperless communications. In another example, the field personnel dispatcher module 220 may add the completed report to the user profile of the subscriber.

In one example, the user device 250 may be associated with the field personnel and includes components such as a geolocation 252 and an on-site service app 254 that corresponds to the device on-site service app 120 of FIG. 1. In one example, the user device 250 may periodically send its calendar schedules and current geolocation to the network server 202. The calendar schedules and the geolocation may be stored and/or used for further processing by the on-site service management platform 216 as described herein. For example, the calendar schedules may be used to determine availability of the field personnel at the requested time of service. In this example, the availability may also be based upon other constraints in addition to the requested time of service.

The requestor device 260 is the customer's electronic device that can be used to send the service request to the network server 202. In one example, the requestor device 260 may include a device identification (ID) 262 and requestor on-site service app 264. In this example, the requestor device 260 may be used by the subscriber to avail the services of a particular service provider based upon the subscriber's desired time and site of service, desired cost, desired field personnel, and/or the like.

Further functionality of the network server 202 and its component features is described in greater detail, below, with respect to examples of methodological implementations of the novel techniques described and claimed herein.

### Example Field Personnel User Device

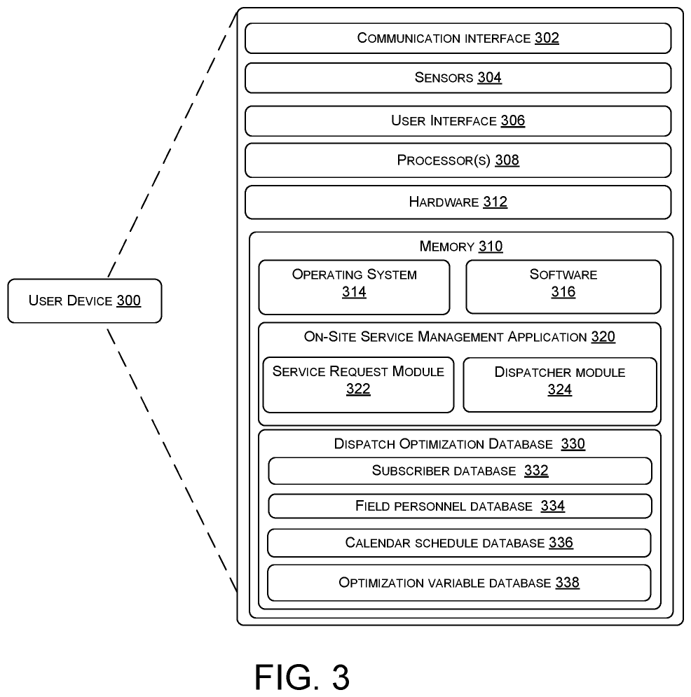

FIG. 3 is a block diagram showing various components of a user device 300 that may be configured to manage the dispatching field personnel associated with the service provider. In one example, the user device 300, which corresponds to the user device 114 of FIG. 1, may also implement the scheduling algorithm as described in the network server 202 of FIG. 2. In some instances, the user device 300 may access the resources of the network server 202 to implement the scheduling algorithm over a larger number of field personnel and/or service providers.

The user device 300 may include a communication interface 302, one or more sensors 304, a user interface 306, one or more processors 308, memory 310, and device hardware 312. The communication interface 302 may include wireless and/or wired communication components that enable the user device to transmit or receive voice or data communication via the wireless carrier network, as well as other telecommunication and/or data communication networks. The sensors 304 may include a signal strength sensor, cameras, and/or a global positioning system (GPS) sensor, among other appropriate sensors. The signal strength sensor may detect signal power in a cellular communication interface and/or a direct communication interface. The cameras may capture images of the environment while the GPS sensor may detect the orientation, movement, and geolocation of the user device 300.

The user interface 306 may enable a subscriber (or field personnel) to enter inputs and read outputs from the user device 300. The user interface 306 may include a data output device (e.g., visual display, audio speakers), and one or more data input devices. The data input devices may include but are not limited to, combinations of one or more keypads, keyboards, mouse devices, touch screens, microphones, speech recognition packages, and any other suitable devices or other electronic/software selection methods. In one example, the user interface 306 may show the calendar schedules of the field personnel, geolocations of dispatched field personnel, details of service cost, confirmation of the dispatch by the customer/requestor, and/or other information that relates to the management of the dispatching of the field personnel to serve requests from the requestor devices.

The memory 310 may be implemented using computer-readable media, such as computer storage media. Computer-readable media includes, at least, two types of computer-readable media, namely computer storage media and communications media. Computer storage media includes volatile and non-volatile, removable, and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage, or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The device hardware 312 may include a modem that enables the user device 300 to perform data communication with the wireless carrier network. The device hardware 312 may further include signal converters (e.g., a digital-to-analog converter, an analog-to-digital converter), antennas, hardware decoders, and encoders, graphics processors, a universal integrated circuit card (UICC) or an embedded UICC (eUICC), and/or the like, that enable the user device 300 to execute applications and provide data communication functions.

The one or more processors 308 and the memory 310 may implement an operating system 314, device software 316, and an on-site service management application 320 that corresponds to the device on-site service app 120 of FIG. 1. Such software may include routines, program instructions, objects, and/or data structures that are executed by the processors 308 to perform particular tasks or implement particular abstract data types. The one or more processors 308 in conjunction with the on-site service management application 320 may further operate and utilize a service request module 322, a dispatcher module 324, and a dispatch optimization database 330, which further includes a subscriber database 332, field personnel database 334, calendar schedule database 336, and optimization variable database 338.

The operating system 314 may include components that enable the user device 300 to receive and transmit data via various interfaces (e.g., user controls, communication interface 302, and/or memory input/output devices). The operating system 314 may also process data using the one or more processors 308 to generate outputs based on inputs that are received via the user interface 306. For example, the operating system 314 may provide an execution environment for the execution of the on-site service management application 320. The operating system 314 may include a presentation component that presents the output (e.g., display the data on an electronic display, store the data in memory, transmit the data to another electronic device, etc.).

The operating system 314 may include an interface layer that enables the on-site service management application 320 to interface with the modem and/or the communication interface 302. The interface layer may comprise public APIs, private APIs, or a combination of both public APIs and private APIs. Additionally, the operating system 314 may include other components that perform various other functions generally associated with an operating system. The device software 316 may include software components that enable the user device to perform functions. For example, the device software 316 may include a basic input/output system (BIOS), bootrom, or a bootloader that boots up the user device 300 and executes the operating system 314 following power-up of the device.

The on-site service management application 320, when executed, manages (as a service provider) the calendar schedule of other user devices. For example, the user device 300 may be associated with a notarial service provider that manages employees associated with a particular number of user devices. In this example, the on-site service management application 320 may use the scheduling algorithm to calculate the optimum operating cost of dispatching the service provider's employees or field personnel to service the requests from requestor devices. The on-site service management application 320 may be a single block of executable instructions or it may be made up of several components. The components included in at least one implementation are described below. However, it is noted that in other implementations, more or fewer components may be configured and that one or more operations attributed to a particular component in the following description may be implemented in one or more other components.

The service request module 322, which corresponds to the service request processor 218 of FIG. 2, may receive and process the one or more service requests from the requestor devices. In one example, the service request module 322 may verify the source of the service requests. For example, the service request module 322 may parse the parameters of the received request to verify whether the device identification is associated with the subscription information that the requestor device provided during the initial sign-up. In this example, the service request module 322 may utilize the subscriber database 332 in verifying the device identification and other parsed parameters associated with the requestor. Alternatively, the service request module 322 may access the subscriber database 232 of the network server 202 of FIG. 2. Upon verification of the request, the service request module 322 may be configured to collate batches of service requests based on the time of receipts and/or based on geographical areas of the sites of services.

The user device dispatcher module 324, which corresponds to the field personnel dispatcher module 220 of FIG. 2, may be configured to implement the scheduling algorithm that optimizes the operating cost of dispatching one or more field personnel to fulfill the one or more service requests. In one example, the scheduling algorithm may use the linear programming or similar programming in the scheduling algorithm. The user device dispatcher module 324 may execute the scheduling algorithm to identify the particular field personnel to be dispatched. The identification of the field personnel may be derived via the calculation of the optimum operating cost as described herein.

The subscriber database 332, which corresponds to subscriber database 232 of FIG. 2, may store the information associated with subscriptions of the on-site service management application. In one example, the information may include personal information of the subscriber, the device identification of subscriber's requestor device, cost preference of the subscriber, field personnel preference of the subscriber, and/or other information that relates to requesting of a particular type of service via the on-site service management application. In another example, the information may include the usage history associated with each of the subscribers. The usage history may include the previous service requests made by the subscriber, the corresponding field personnel that served the request, the completed reports for each of the past transactions such as completed reports of notarial transactions, the cancellations of dispatches received by the subscriber, and/or the like.

The field personnel database 334, which corresponds to the field personnel database 234 of FIG. 2, may store the information associated with field personnel who subscribed to the on-site service management application. In one example, the information may include personal information of the field personnel, the device identification of field personnel's user device, calendar schedules of each of the field personnel's user devices, cost preference of the field personnel, field personnel preference of availability, field personnel preference of length of service, and/or the like. In another example, the information may include previous dispatches made by the field personnel, completed reports of dispatches that can be sent to agencies for tax purposes or any kind of reporting, and/or the like. In some instances, user device 300 may access the field personnel database 234 of the network server 202 to retrieve other information that was not stored in the user device 300 due to storage capacity limitations.

The calendar schedule database 336 may store the current itinerary for the user device 300. In one example, the calendar schedule database 336 may be automatically updated by the network server 202 of FIG. 2. In this regard, the network server 202 may access the calendar application of the user device 300. Particularly, the network server 202 may communicate with the on-site service management application 320 to access the calendar application. Given a situation where the user device 300 is associated with a service provider that manages other user devices, the calendar schedule database 336 may store the schedules of the dispatched field personnel or the field personnel under the user device 300 as the service provider.

The optimization variable database 338, which corresponds to the optimization variable database 236 of FIG. 2, may store the information associated with the implementation of the scheduling algorithm. In one example, the information may include the decision variables, one or more constraint functions, and objective functions for the linear programming as scheduling algorithm, and/or the like. In this example, the one or more processors 308 in conjunction with the user device dispatcher module 324 may utilize the information from the subscriber database 332, field personnel database 334, calendar schedule database 336, and/or the optimization variable database 338 to implement the scheduling algorithm as described herein.

### Example Implementation for Identifying Availability of Field Personnel

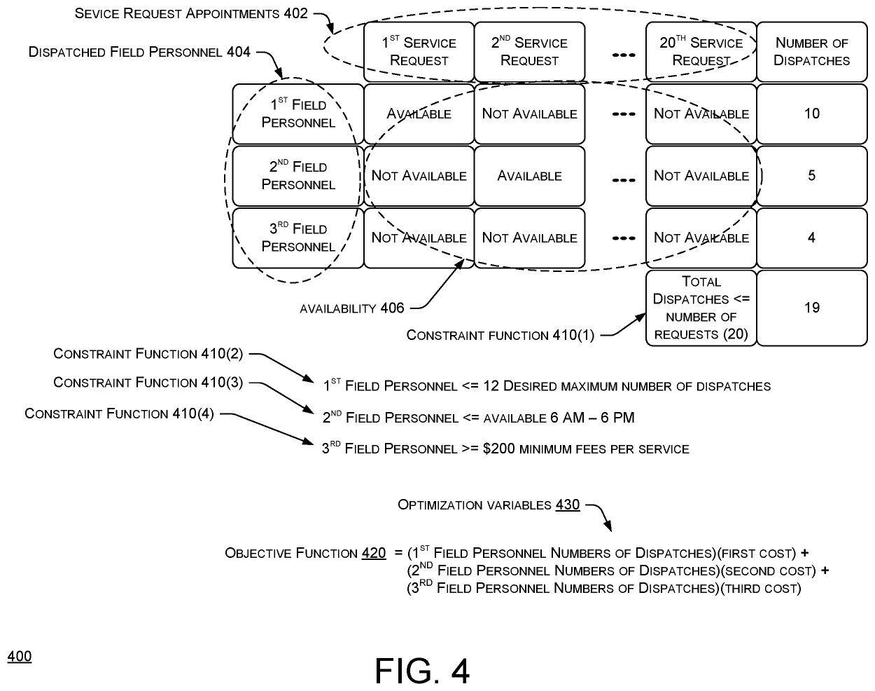

FIG. 4 illustrates an example implementation of a scheduling algorithm 400 that may be used by the on-site service management platform to identify the field personnel to be dispatched. In one example embodiment, the scheduling 400 may use linear programming to calculate the optimum operating cost for dispatching one or more field personnel to fulfill the service requests. As shown, the implementation of the scheduling algorithm 400 may include a batch of service requests 402, one or more field personnel 404, availability 406, constraint functions 410, and an objective function 420 that utilizes optimization variables 430 for calculating the optimum operating cost of dispatching the one or more field personnel 404 to cover the service requests 402. The objective function 420 may include real-valued function whose value can be minimized subject to the constraint functions such as the constraint functions 410. In one embodiment, a minimized value corresponds to the optimized cost of dispatching the field personnel to cover the service requests. In this embodiment, the field personnel to be dispatched may include available calendar schedule based upon the requested time of service. For example, the network server upon execution of the scheduling algorithm may only present a selection of field personnel that are actually available based upon the requested time of service. In some cases, even if the field personnel are available, the updating of the field personnel calendar schedule may be initiated upon confirmation by the requestor devices of their desired/selected field personnel.

In one example, the constraint functions 410 may include a first constraint function 410(1) that limits the total number of dispatches to be equal to or less than the number of service requests 402. In this example, the calculated optimum operating cost in the objective function 420 may include a total number of dispatches that can be equal to or less than the number of service requests 402. Given a situation where the number of dispatches made is less than the number of service requests 402, then one of the service requests 402 is pending fulfillment. In this case, the on-site services management platform 216 may send a notification to the administrator of the service provider of the pending fulfillment in the one or more of the service requests 402.

In another example, the preconfigured constraint may include a constraint function 410(2) that limits the number of dispatches for the first field personnel to a maximum of 12 dispatches. In another example, the preconfigured constraint function may include a constraint function 410(3) that limits the number of hours of the second field personnel to 6 AM-6 PM only. Yet, in another example, the preconfigured constraint function may include a constraint function 410(4) that limits the minimum fees per service that the third field personnel may obtain when dispatched to render services. In these examples, the objective function 420 may utilize the constraint functions when calculating the optimal cost of dispatching one or more field personnel to cover the service requests 402.

### Example Implementation of a Field Personnel Calendar

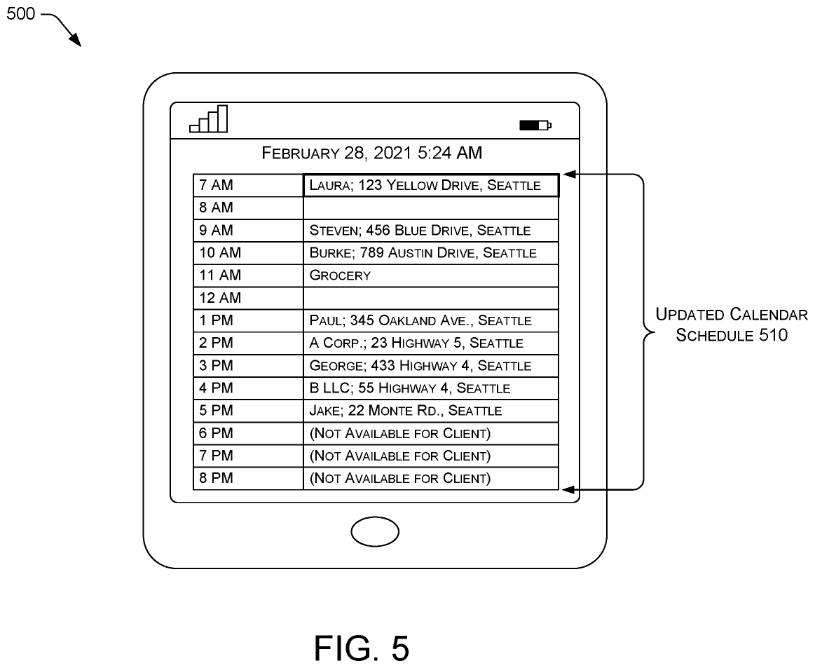

FIG. 5 is an example calendar schedule 500 of a user device that may be updated following the confirmation of the field personnel to be dispatched to fulfill the service requests from requestor devices. In one embodiment, the calendar schedule 500 may include updated calendar schedule 510 that displays the itinerary of the field personnel associated with the user device to be dispatched for service. For example, the field personnel include a mobile notary public that drives around a geographical area to notarize documents. In this example, the updated calendar schedule 510 may be uploaded by the network server, such as the network server 202 of FIG. 2, following the calculation of the optimum operating cost as described herein.

In one embodiment, the user device may continuously send its present geolocation to the network server. Given a situation where the network server may detect changes in the parameters such as the presence of heavy traffic that may cause deviations in the ETA of the field personnel to reach the site of service, then the network server may update the optimization variables that were used in initial identification of the availability of the field personnel to be dispatched. The network server may use the updated optimization variables in updating the calendar schedules of the corresponding user devices.

### Example Implementation of Updating User Device—Calendar Schedule

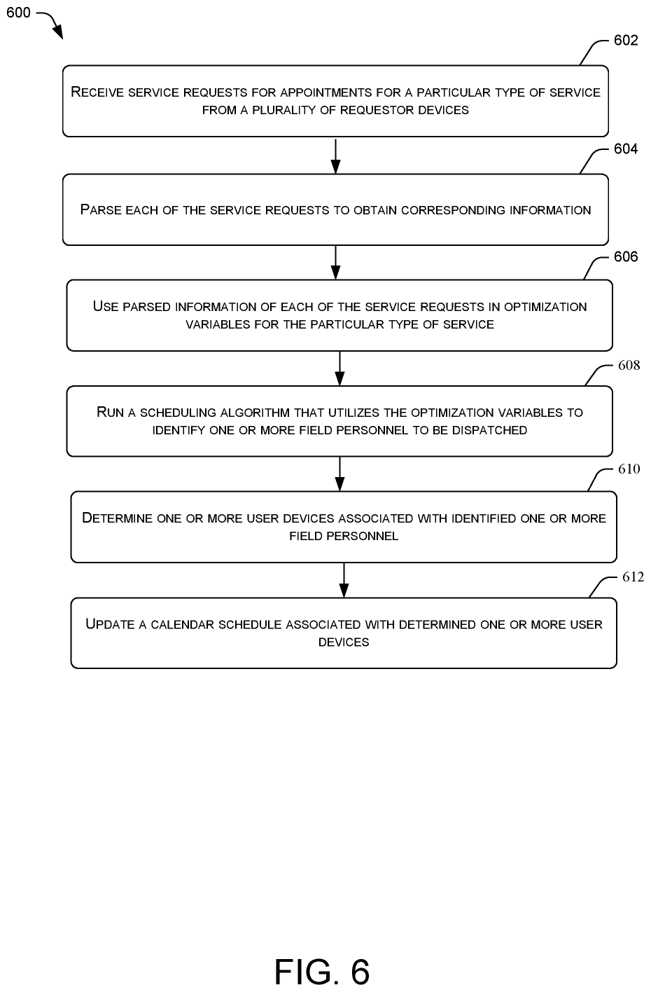

FIG. 6 is a flow diagram 600 that depicts a methodological implementation of a technique for updating calendar schedules of the user devices associated with the one or more field personnel to be dispatched to fulfill the service requests. In the following discussion of FIG. 6, continuing reference is made to the elements and reference numerals shown in and described with respect to the network server 202 of FIG. 2. Further, certain operations may be ascribed to particular system elements shown in previous figures. However, alternative implementations may execute certain operations in conjunction with or wholly within a different element or component of the system(s). To the extent that certain operations are described in a particular order, it is noted that some operations may be implemented in a different order to produce similar results.

At block 602, the network server 202 may receive service requests for appointments for a particular type of service from a plurality of requestor devices. For example, a batch of service requests may be received from multiple requestor devices 116(1)-116(N). In this example, the batch of service requests may be compiled based upon the geographic area of the requestor devices 116. In other cases, the batch of service requests may be compiled based upon a time of receipt of the requests. Without limitation, the service requests may include notarial, plumbing, or electrical type of services.

At block 604, the network server 202 may parse each of the received service requests to obtain corresponding information that is associated with each of the service requests. In one example, the information may include date and time of service, site of service, price range that the service requestor is willing to pay for the service, requestor device identification, field personnel preference in some cases, service fees, and a user profile that can be shared by the requestor device. In this example, the value(s), range, and/or parameters of the information may be used in preconfigured optimization variables for calculating a minimum cost for dispatching the field personnel to cover the service requests.

At block 606, the network server 202 may use parsed information of each of the service requests in preconfigured optimization variables for the particular type of service. In one example, the preconfigured optimization variables may represent the availability and/or preferred service time of the field personnel that can cover the service requests, the amount that each of the field personnel charges, geolocations of the field personnel, etc. In this example, the preconfigured optimization variables may be used in constraint functions to calculate the objective function that can include identifying the one or more field personnel to be dispatched at an optimized cost.

In one example, the constraint function may include limiting a traveling distance between particular field personnel and the site of service. In this example, the preconfigured optimization variables may include a maximum distance that the particular field personnel can service, and an amount of gas or cost to spend to travel from current geolocation of the particular field personnel to the site of service. In another example, the constraint function may include limiting the number of dispatches to be assigned to the particular field personnel. In this example, the preconfigured optimization variables may include the number of times that the field personnel completed service at a particular time of the day, and so on.

At block 608, the network server 202 may run a scheduling algorithm that utilizes the optimization variables to identify one or more field personnel to be dispatched to fulfill the received service requests. In one embodiment, the network server 202 may use a linear programming algorithm to calculate the optimum operating cost of dispatching the one or more field personnel to fulfill the received service requests. In this embodiment, the linear programming algorithm may include an objective function of identifying the one or more field personnel to be dispatched to fulfill the received service requests at a minimal cost and maximum profits. The objective function may comply with the one or more constraint functions as described herein.

In some cases, the network server 202 may employ one or more trained machine-learning algorithms to infer or identify the field personnel to be dispatched based upon non-linear parameters in the parsed information. For example, a particular field personnel is associated with a historical data that includes a high rating in a social media review. In this example, the machine-learning algorithms may utilize the historical data to infer a likelihood that the particular field personnel can provide the service. In some cases, the network server 202 may rank different field personnel who may be able to fulfill the service requests. In such cases, the network server 202 may select the highest ranked field personnel to fulfill the service request(s).

At block 610, the network server 202 may determine one or more user devices associated with identified one or more field personnel to be dispatched. In one example, the scheduling algorithm may be used to identify the one or more field personnel to be dispatched. In this case, the network server 202 may determine the one or more user devices associated with the identified one or more field personnel to access and automatically update the calendar schedule of the corresponding one or more user devices. In some cases, the updating may be performed after confirmation by the requestor device. In this case, the network server may present available and identified field personnel first to the requestor device before updating the calendar schedule associated with the selected field personnel.

At block 612, the network server 202 may update the calendar schedule of determined one or more user devices. In one example, the updating may include accessing the calendar app of the user device that is associated with identified field personnel and entering the requested time of service into the user device's calendar schedule.

### Example Implementation of a Scheduling Algorithm

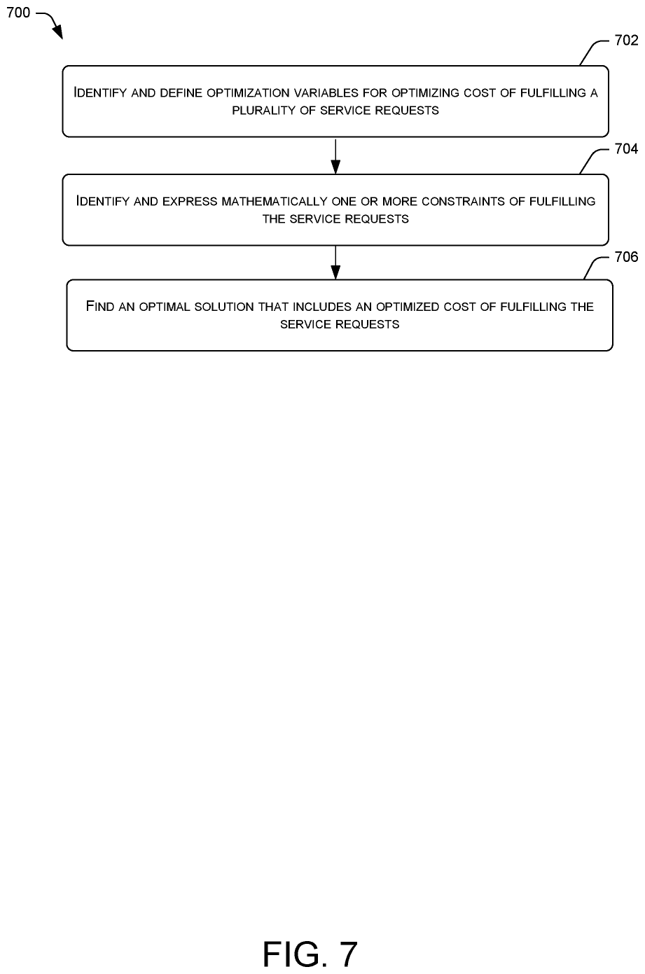

FIG. 7 is a flow diagram 700 that depicts a methodological implementation of a technique for carrying out a scheduling algorithm to identify the field personnel to be dispatched. In the following discussion of FIG. 7, continuing reference is made to the elements and reference numerals shown in and described with respect to the network server 202 of FIG. 2. Further, certain operations may be ascribed to particular system elements shown in previous figures. However, alternative implementations may execute certain operations in conjunction with or wholly within a different element or component of the system(s). To the extent that certain operations are described in a particular order, it is noted that some operations may be implemented in a different order to produce similar results.

At block 702, the network server 202 may identify and define optimization variables for optimizing cost of fulfilling a plurality of service requests. Without limitation, the optimization variables may include a number of dispatches per day that particular field personnel wanted to fulfill, calculated distance from geolocation of the particular field personnel to a site service, distance limit that the particular field personnel prefer to serve, time period during the day that the particular field personnel is available, geographic limit that the particular field personnel wanted to serve, and so on. In one example, the network server 202 may identify these optimization variables that can be used to calculate the optimized cost of fulfilling the service requests.

At block 704, the network server 202 may identify and express mathematically one or more constraints of fulfilling the service requests. In one example, a first constraint function may limit the total number of dispatches to be equal to or less than an arbitrary number of service requests. Given a situation where the number of dispatches made is less than the number of service requests, then one or more of the service requests is pending fulfillment. In another example, a second constraint function may limit the number of hours of particular field personnel to 6 AM-6 PM only. In another instance, a third constraint function may limit minimum fees per service that the field personnel may obtain when dispatched to render services. In these examples, the network server may identify and express mathematically all the constraint functions that can be formed from parsed information such as the parsed information at block 604 of FIG. 6.

At block 706, the network server 202 may find an optimal solution that includes an optimized cost of fulfilling the service request. In one example, the network server 202 may run a linear programming using the one or more constraints as described above. In this example, the linear programming may generate the optimal solution that includes the optimized cost of fulfilling the service requests.

### Example Implementation of Updating Field Personnel User Device Calendar

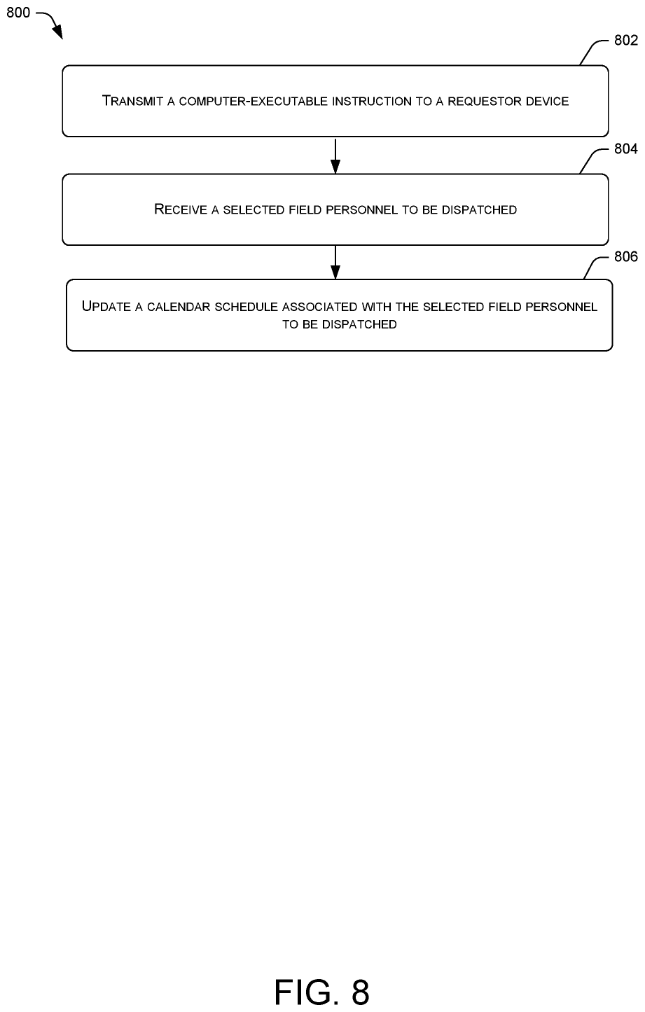

FIG. 8 is an example of a flow diagram 800 that depicts a methodological implementation of a technique for performing an update on a user device—calendar schedule of an identified field personnel to be dispatched.

At block 802, the network server 202 may transmit a computer-executable instruction to a requestor device. In one example, the computer-executable instruction may present a selection of identified field personnel on a requestor device-user interface. In this example, the selection may include the identified one or more field personnel that can fulfill the service request.

At block 804, the network server 202 may receive confirmation or a selection from the requestor device.

At block 806, the network server 202 may update a calendar schedule of the selected field personnel to be dispatched.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer-readable storage media storing computer-executable instructions that upon execution cause one or more computers to collectively perform acts comprising:
receiving a plurality of service requests for appointments for a particular type of service from a plurality of requestor devices;
parsing each of received service requests to obtain information associated with each of the service requests;
use parsed information in optimization variables for the particular type of service;
performing a scheduling algorithm that utilizes the optimization variables to identify one or more field personnel to be dispatched and fulfill the service requests for the particular type of service;
determining one or more user devices associated with identified one or more field personnel to be dispatched; and
updating a calendar schedule of determined one or more user devices.

2. The one or more computer-readable storage media of claim 1, wherein the particular type of service includes a notarial service.

3. The one or more computer-readable storage media of claim 2, wherein the information includes a requested time and site of service of each of the service requests.

4. The one or more computer-readable storage media of claim 1, wherein the optimization variables include an availability of the one or more field personnel to be dispatched to cover the service requests.

5. The one or more computer-readable storage media of claim 1, wherein the scheduling algorithm includes a linear programming that is used to calculate an optimum operating cost when dispatching the one or more field personnel to fulfill the service requests.

6. The one or more computer-readable storage media of claim 5, wherein the linear programming utilizes at least one constraint function that includes a geographical location preference of the one or more field personnel.

7. The one or more computer-readable storage media of claim 5, wherein the linear programming utilizes at least one constraint function that includes a total number of dispatches to be equal or less than a total number of service requests.

8. The one or more computer-readable storage media of claim 1, wherein the acts further comprise:
transmitting a computer-executable instruction to a particular requestor device;
receiving a selected field personnel from the particular requestor device; and
updating the calendar schedule of a user device associated with the selected field personnel.

9. The one or more computer-readable storage media of claim 8, wherein the computer-executable instruction presents a selection of identified one or more field personnel to a user interface of the particular requestor device.

10. A network server, comprising:
one or more processors; and
memory including a plurality of computer-executable components that are executable by the one or more processors to perform a plurality of actions, the plurality of actions comprising:
receiving a plurality of service requests for appointments for a particular type of service from a plurality of requestor devices;
parsing each of received service requests to obtain information associated with each of the service requests;
use parsed information in optimization variables for the particular type of service;
performing a scheduling algorithm that utilizes the optimization variables to identify one or more field personnel to be dispatched and fulfill the service requests for the particular type of service;
determining one or more user devices associated with identified one or more field personnel to be dispatched; and
updating a calendar schedule of determined one or more user devices.

11. The network server of claim 10, wherein the particular type of service includes a notarial service.

12. The network server of claim 11, wherein the information includes a requested time and site of service of each of the service requests.

13. The network server of claim 10, wherein the optimization variables include an availability of the one or more field personnel to be dispatched to cover the service requests.

14. The network server of claim 10, wherein the scheduling algorithm includes a linear programming that is used to calculate an optimum operating cost when dispatching the one or more field personnel to fulfill the service requests.

15. The network server of claim 14, wherein the linear programming utilizes at least one constraint function that includes a geographical location preference of the one or more field personnel.

16. The network server of claim 14, wherein the linear programming utilizes at least one constraint function that includes a total number of dispatches to be equal or less than a total number of service requests.

17. The network server of claim 10, wherein the plurality of actions further comprising:
transmitting a computer-executable instruction to a particular requestor device;
receiving a selected field personnel from the particular requestor device; and
updating the calendar schedule of a user device associated with the selected field personnel.

18. A computer-implemented method, comprising:
receiving a plurality of service requests for appointments for a notarial service from a plurality of requestor devices;
parsing each of received service requests to obtain information associated with each of the service requests;
use parsed information in optimization variables for the notarial service;
performing a scheduling algorithm that utilizes the optimization variables to identify one or more field personnel to be dispatched for the notarial service;
determining one or more user devices associated with identified one or more field personnel to be dispatched; and
updating a calendar schedule of determined one or more user devices.

19. The computer-implemented method of claim 18, wherein the information includes a requested time and site of service of each of the service requests.

20. The computer-implemented method of claim 19, wherein the optimization variables include an availability of the one or more field personnel to be dispatched to cover the service requests.
